(19) United States
(12) Patent Application Publication
(10) Pub. No.: US 2018/0312752 A1
(43) Pub. Date: Nov. 1, 2018

(54) METHODS OF MAKING CARBON QUANTUM DOTS

(71) Applicant: Chung Yuan Christian University, Taoyuan City (TW)

(72) Inventors: Wei-Jen LIU, Taoyuan City (TW); Chih-Wei LEI, Taoyuan City (TW)

(73) Assignee: Chung Yuan Christian University, Taoyuan City (TW)

(21) Appl. No.: 15/581,179

(22) Filed: Apr. 28, 2017

(51) Int. Cl. C09K 11/65

(52) U.S. Cl. CPC C09K 11/65

(57) ABSTRACT

Disclosed herein are carbon quantum dots (CQDs), and methods for producing the CQDs. The method includes the steps of, (a) reacting CQD precursors and a liquid medium at a temperature no more than 100° C. for a first period of time; and (b) adding a monosaccharide to the reaction mixture of the step (a) and allowing the reaction to proceed for a second period of time to produce the CQDs. The CQDs thus produced are about 1-5 nm in size, and pH sensitive, thus may emit blue light at acidic condition and yellow light at alkaline condition.

### BACKGROUND OF THE INVENTION

### 1. Field of the Invention

The present disclosure relates in general, to the field of nanotechnology. More particularly, to carbon quantum dots (CQDs) and methods of producing CQDs.

### 2. Description of Related Art

Carbon quantum dots (CQDs) are nanometer-sized particles with unique optical property suitable for broad range applications, such as diagnosing and imaging at molecular and cellular levels. CQDs are conventionally synthesized via hydrothermal (HT) process. Though CQDs emitting wide range of colors may be easily produced by the HT process, however, the process involves reaction under high temperature and/or pressure, thereby rendering HT process difficult to scale-up to meet the industrial level of gross production.

Accordingly, there exists in this art an improved method of making CQDs, in which a mild reaction condition, that is, a condition that does not involve reaction under high temperature and/or pressure, is sufficient to produce CQDs.

### SUMMARY

Embodiments of the present disclosure are directed to methods of making carbon quantum dots (CQDs), and uses thereof. Aspects of the present disclosure are directed to methods of making CQDs at relatively mild conditions, and CQDs thus produced are pH sensitive, thus may emit blue to yellow light in accordance with a change in the surrounding pH value. The present CQDs thus are useful in many areas, such as imaging, bio-sensing, bio-labeling, medical diagnosis, gene expression studies, and the like.

Accordingly, it is the first aspect of the present disclosure to provide a method of making CQDs. The method includes the steps of, (a) reacting carbon quantum dot precursors and a liquid medium at a temperature no more than 100° C. for a first time period; (b) adding a monosaccharide to the mixture of the step (a) and allowing the reaction to continue for a second time period to produce the CQDs.

According to embodiments of the present disclosure, the carbon quantum dot precursors are in liquid form. Exemplary liquid carbon quantum dot precursors include, but are not limited to, methanol, ethanol, propanol, isopropanol, ketone, ethanolamine, ethylenediamine, N-methylpyrrolidone (NMP), and a combination thereof. In one preferred embodiment, ethanol is used as the carbon quantum dot precursor.

According to embodiments of the present disclosure, the liquid medium has a pH value ranges from 1 to 13, such as 1, 3, 7, 9, and 13. According to embodiments of the present disclosure, the liquid medium is an acidic solution or an alkaline solution. Exemplary acidic solution that may be used as the liquid medium include, but are not limited to, hydrogen chloride solution, nitric acid solution, sulfuric acid solution, phosphoric acid solution, and a combination thereof. Exemplary alkaline solution that may be used as the liquid medium include, but are not limited to, sodium hydroxide, potassium hydroxide, ammonium hydroxide and a combination thereof.

Exemplary monosaccharides that may be used in the step (b) of the present method include, but are not limited to, glucose, fructose, arabinose, threose, and ribulose. Preferably, glucose is added in the step (b).

According to embodiments of the present disclosure, the first time period is at least 15 minutes, and the second time period is about 15 minutes to 24 hours. In some embodiments, the first time period is same as the second time period. In other embodiments, the second time period is longer than the first time period.

According to embodiments of the present disclosure, the CQDs thus produced are about 1-5 nm in size, and are pH sensitive. In some embodiments, the present CQDs emit blue light at the wavelength between 420-480 nm in an acidic condition (e.g., pH 1), and gradually change to emitting yellow-green light at the wavelength between 480-520 nm as the pH value increased (e.g., pH 7 or 9), and to emitting yellow light at the wavelength between 520-570 nm when pH value reaches a strong alkaline condition (e.g., pH 13).

The details of one or more embodiments of the invention are set forth in the accompanying description below. Other features and advantages of the invention will be apparent from the detail descriptions, and from claims.

### BRIEF DESCRIPTION OF THE DRAWINGS

The present description will be better understood from the following detailed description read in light of the accompanying drawings, where:

FIG. 1A is a representative TEM photograph of the CQDs in accordance with one embodiment of the present disclosure;

FIG. 1B is a bar graph depicting the particle size distribution of the CQDs in accordance with one embodiment of the present disclosure;

FIG. 2 illustrates the absorption properties of CQDs at pH 1, 7 and 13 in accordance with one embodiment of the present disclosure;

FIG. 3 illustrates the surface chemistry of CQDs at pH 1, 7 and 13 in accordance with one embodiment of the present disclosure;

FIG. 4 illustrates the photoluminescence properties of CQDs at pH 1, 7, 9 and 13 in accordance with one embodiment of the present disclosure;

FIG. 5 illustrates the photoluminescence properties of CQDs in the presence of various amounts of glucose in accordance with one embodiment of the present disclosure; and

FIG. 6 illustrates the photoluminescence properties of CQDs in the presence of various amounts of sucrose in accordance with one embodiment of the present disclosure.

### DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

### 1. Definitions

For convenience, certain terms employed in the context of the present disclosure are collected here. Unless defined otherwise, all technical and scientific terms used herein have the same meaning as commonly understood by one of the ordinary skill in the art to which this invention belongs.

Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise. Also, as used herein and in the claims, the terms “at least one” and “one or more” have the same meaning and include one, two, three, or more.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

As used herein, the term “monosaccharides” includes both aldoses and ketoses. Representative aldoses i.e., monosaccharides containing a terminal aldehyde (—CHO) group which may be employed include, for example, glucose, arabinose and threose. Representative ketoses i.e., monosaccharides containing a keto group which may be employed include, for example, fructose and ribulose.

The term “carbon quantum dot (CQD)” as used herein refers to carbon nanocrystals respectively range from about 1-5 nm, such as 1, 2, 3, 4, and 5 nm; preferably about 2-3 nm, such as 2, 2.1, 2.2, 2.3, 2.4, 2.5, 2.6, 2.7, 2.8, 2.9 and 3.0 nm; more preferably about 2.4 nm. In a preferred embodiment, each CQDs is to about 2.4 nm in diameter. CQDs have high quantum yields, which make them particularly useful for optical applications. CQDs are fluorophores that fluoresce by forming excitons, which can be regarded as excited state of traditional fluorophores, but have much longer lifetimes of up to 200 nanoseconds, this property provides CQDs with low photobleaching.

### 2. The Present CQDs, Methods of Producing the Same and Uses Thereof

The present disclosure as embodied and broadly described herein, relates to carbon quantum dots (CQDs), methods of making CQDs, and uses thereof. In particular, embodiments of the present disclosure include making CQDs at relatively mild conditions, and the thus produced CQDs are pH sensitive and may emit light at different wavelengths. The present CQDs thus are useful in many areas, such as imaging, bio-sensing, bio-labeling, medical diagnosis, gene expression studies, and the like.

In general, embodiments of the present disclosure are directed to methods of making CQDs. The method includes, at least the steps of, (a) reacting carbon quantum dot precursors and a liquid medium at a temperature of no more than 100° C. for a first time period; and (b) adding a monosaccharide to the mixture of the step (a) and allowing the reaction to continue for a second time period to produce the CQDs.

According to embodiments of the present disclosure, the carbon quantum dot precursors are in liquid form. Examples of liquid material suitable used as CQD precursors include, but are not limited to, methanol, ethanol, propanol, isopropanol, ketone, ethanolamine, ethylenediamine, N-methylpyrrolidone (NMP), and a combination thereof. In one preferred embodiment, the CQD precursors are ethanol.

According to embodiments of the present disclosure, the liquid medium suitable for reacting with CQDs precursors has a pH value between 1 to 13, thus the liquid medium may be an acidic solution or an alkaline solution. Examples of acidic solution suitable used as the liquid medium include, but are not limited to, hydrogen chloride solution, nitric acid solution, sulfuric acid solution, phosphoric acid solution, and a combination thereof. Examples of alkaline solution suitable used as the liquid medium include, but are not limited to, sodium hydroxide, potassium hydroxide, ammonium hydroxide and a combination thereof.

According to aspects of the present disclosure, in the step (a), CQDs precursors and the liquid medium are reacted at a reaction temperature of no more than 100° C. for a first time period. Exemplary reaction temperature is between 4-99° C., such as 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99° C. Preferably, the reaction temperature is between 60-80° C., such as 60, 61, 62, 63, 64, 65, 66, 67, 68, 69, 70, 71, 72, 73, 74, 75, 76, 77, 78, 79, and 80° C. Most preferably, about 75° C.

In the step (b), a monosaccharide is added to the reaction mixture of the step (a), and the reaction is allowed to continue for a second time period until CQDs are produced. Preferably, the monosaccharide is added after the CQDs precursors and the liquid medium of the step (a) has been reacted for at least the first time period. If the monosaccharide is introduced into the reaction mixture too soon, such as upon mixing the CQDs precursors and the liquid medium in the step (a), then each CQDs thus produced would have dark color and would not give rise to desirable bright emission. Exemplary monosaccharide that may be used in the present method include, but are not limited to, glucose, fructose, arabinose, threose, and ribulose. Preferably, in the step (b), glucose is added and the reaction is allowed to proceed for the second time period until CQDs are produced.

Exemplary first and second periods of time is between 0.25-24 hrs, such as 0.25, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, and 24 hrs. Preferably, each of the first and second periods of time is about 0.25-1 hrs, such as 0.25, 0.5, 0.6, 0.7, 0.8, 0.9 and 1 hr. In some embodiments, both the first and second periods of time are about 15 minutes. In other embodiments, the first period of time is about 15 minutes, and the second period of time is about 1 hour.

The reaction as described above can be conducted in a single reaction vessel, thus the CQDs are produced in situ. The reaction condition such as the reaction temperature and the period of the reaction may be controlled using known methods and systems. Specific examples are described in the working examples.

According to embodiments of the present disclosure, the CQDs thus produced is pH sensitive, in which the peak emission (i.e., the emitted light or the color) varies with the surrounding pH value. Specifically, the color of the CQDs is determined by the pH value of the surrounding environment, the smaller the pH value, the bluer or more towards the blue end of the spectrum of the fluorescence; while the higher the pH value, the redder, or more towards the red end of the fluorescence. For example, in acidic condition (e.g., pH 1.0), the present CQDs emit a blue light, with a wavelength between 420 nm to 480 nm; whereas in alkaline condition, the emitted light is yellow, with a wavelength between 520 nm to 570 nm. For mild acidic or mild alkaline condition (e.g., pH 5.0 or 9.0), the color of the fluorescence emitted from the present CQDs is between blue and green, in which the wavelength is between 480-520 nm.

The present CQDs are useful for detecting, localizing, and/or quantifying biological targets, cellular events, diagnostics, cancer and disease imaging, gene expression, and the like. Biological targets that may be detected, localized and/or quantified by the present CQDs include, but are not limited to, viruses, bacteria, cells, tissues, artificially constituted nanostructures (e.g., micelles), proteins, polypeptides, antibodies, antigens, aptamers, haptens, polynucleotides, and the like.

The present invention will now be described more specifically with reference to the following embodiments, which are provided for the purpose of demonstration rather than limitation.

### EXAMPLES

### Example 1 Preparation and Characterization of Carbon Quantum Dots

In a vessel, mixed 100 mL ethanol (95%), which was pre-heated to 75° C., and 15 mg NaOH, and allowed the mixture to react for 30-40 min with continuous agitation, until a light yellow solution was produced. Let the light yellow solution cooled to ambient temperature, then filtered to remove any non-reacted substance, and collected the filtrate. Suitable amounts of hydrochloric acid were added to the filtrate until it reached the desired pH value, such as 1, 5, 7, 9, or 13. The filtrate with any of the designated pH was then concentrated and dried to produce the desired carbon quantum dots.

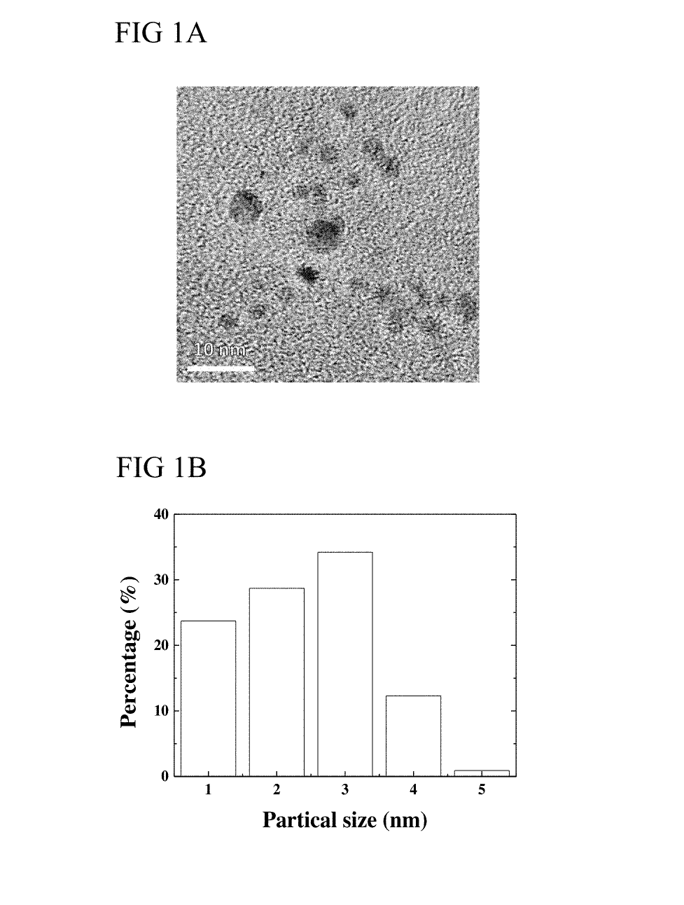

The thus produced carbon quantum dots were then characterized by use of transmission electron microscopy (TEM), Fourier Transform Infrared Spectroscopy (FTIR), photoluminescence (PL) spectroscopy, as well as high resolution X-ray photoelectron spectrometer (XPS). Results are illustrated in FIGS. 1 to 4.

FIG. 1A is a representative TEM photograph of the thus produced CQDs, whereas FIG. 1B is a bar graph depicting the particle size distribution of the thus produced CQDs. It was found that each CQDs has a size that ranges from about 1 to 5 nm in diameter, with an average of 2.4 nm in diameter.

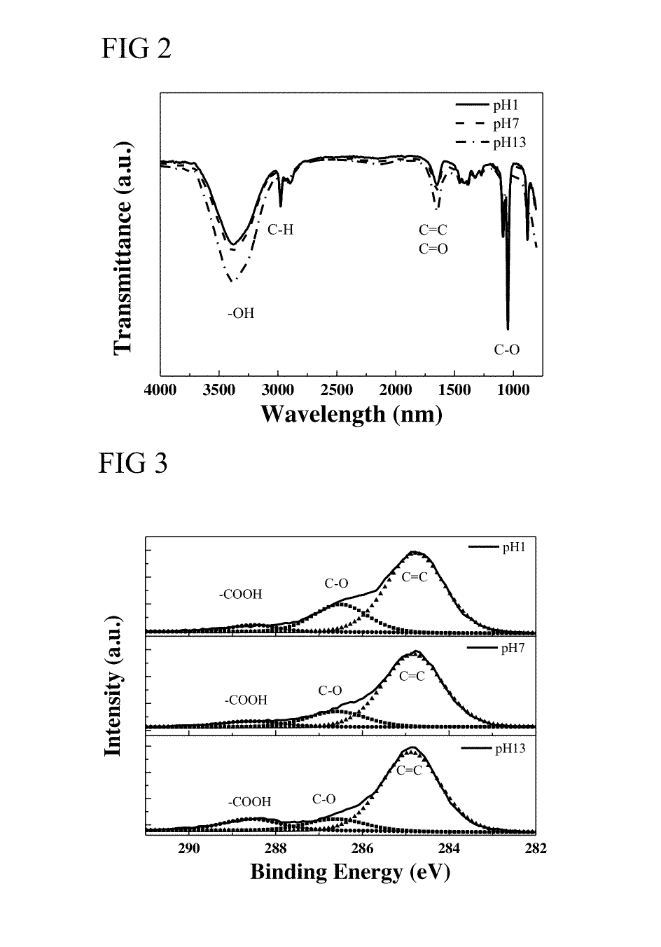

FIGS. 2 and 3 respectively illustrate the absorption and surface chemistry properties of CQDs at pH 1, 7 and 13, in which the percentage of —COOH group increased as the ambient pH moved from acidic pH to alkaline pH, which indicated that CQDs were relatively more oxidized in the alkaline condition.

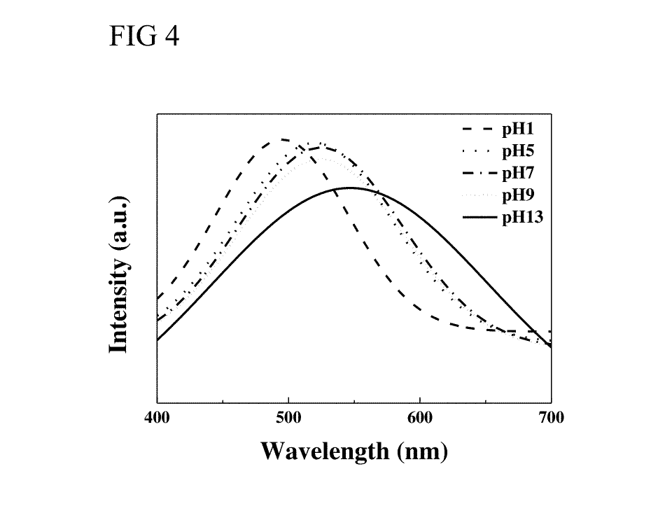

FIG. 4 illustrates the photoluminescence properties of CQDs at pH 1, 7, 9 and 13. It is evident that as the ambient pH moved from acidic pH to alkaline pH, the emission wavelength moved from blue toward red, indicating that CQDs emitted blue light in acidic condition, and yellow to red light in alkaline condition.

### Example 2 Effects of Glucose and/or Sugar on the Emission Intensity of Carbon Quantum Dots of Example 1

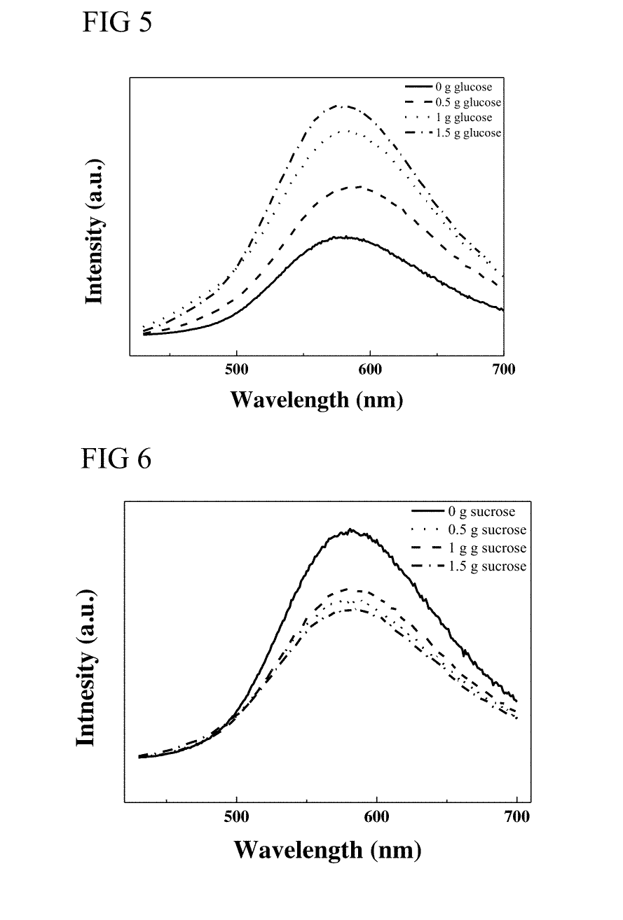

In general, carbon quantum dots were prepared in accordance with the procedures of example 1, except designated amounts of glucose or sugar (0.5, 1 or 1.5 g) were added after NaOH and ethanol had been reacted for 15 minutes. The reaction was allowed to proceed for another 15 minutes, until a light yellow solution was produced. Let the light yellow solution cooled to ambient temperature, then filtered to remove any non-reacted substance, and collected the filtrate The thus produced carbon quantum dots were characterized by photoluminescence (PL) spectroscopy, and results are illustrated in FIGS. 5 and 6.

According to FIG. 5, the emission intensity of CQDs increased with an increased amount of glucose. By contrast, addition of a disaccharide (e.g., sugar) suppressed the emission intensity of CQDs (FIG. 6).

Taken together, the finding of the present example confirmed that addition of a monosaccharide (e.g., glucose) could effectively enhance the emission of thus produced CQDs.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A method of making carbon quantum dots, comprising:
(a) reacting carbon quantum dot precursors and a liquid medium at a temperature no more than 100° C. for a first time period; and
(b) adding a monosaccharide to the mixture of the step (a) and allowing the reaction to continue for a second time period to produce the carbon quantum dots.

2. The method of claim 1, wherein the carbon quantum dot precursors are selected from the group consisting of, methanol, ethanol, propanol, isopropanol, ketone, ethanolamine, ethylenediamine, N-methylpyrrolidone (NMP), and a combination thereof.

3. The method of claim 2, wherein the carbon quantum dot precursors are ethanol.

4. The method of claim 1, wherein the liquid medium has a pH value ranges from 1 to 13.

5. The method of claim 4, wherein the liquid medium is an acidic solution or an alkaline solution.

6. The method of claim 5, wherein the acidic solution is selected from the group consisting of, hydrogen chloride solution, nitric acid solution, sulfuric acid solution, phosphoric acid solution, and a combination thereof.

7. The method of claim 5, wherein the alkaline solution is sodium hydroxide, potassium hydroxide, ammonium hydroxide and a combination thereof.

8. The method of claim 7, wherein the alkaline solution is sodium hydroxide.

9. The method of claim 1, wherein the monosaccharide is selected from the group consisting of glucose, fructose, arabinose, threose, and ribulose.

10. The method of claim 9, wherein the monosaccharide is glucose.

11. The method of claim 9, wherein the first time period is at least 15 minutes, and the second time period is between 15 minutes and 24 hours.

12. The method of claim 1, wherein each of the carbon quantum dots has a diameter of 1-5 nm.

13. The method of claim 12, wherein the carbon quantum dots emit blue light having a wavelength between 420 nm to 480 nm at an acidic condition.

14. The method of claim 12, wherein the carbon quantum dots emit yellow light having a wavelength between 520 nm to 570 nm at an alkaline condition.
